(19) United States
(12) Patent Application Publication
(10) Pub. No.: US 2025/0080790 A1
(43) Pub. Date: Mar. 6, 2025

(54) REMOTE ENVIRONMENT PRESENTATION SYSTEM

(71) Applicant: TZUYANG HUANG, TAIPEI CITY (TW)

(72) Inventor: TZUYANG HUANG, TAIPEI CITY (TW)

(21) Appl. No.: 18/818,583

(22) Filed: Aug. 28, 2024

(30) Foreign Application Priority Data
Aug. 31, 2023 (TW) 112133054
Aug. 31, 2023 (TW) 112209364

(51) Int. Cl. H04N 21/414; F24F 11/64; F24F 110/10

(52) U.S. Cl. CPC H04N 21/414; F24F 11/64; F24F 2110/10

(57) ABSTRACT

A remote environment presentation system is disclosed. It includes several audio-visual capturing modules, a relay server, a selector, a fragrance sprayer, a video playback device, a sound playback device, an air conditioner and a central control device. The present invention utilizes the audio-visual capturing module to obtain images and surrounding sounds of a distant target environment and presents them in an enclosed space through the video playback device and the sound playback device. The fragrance sprayer and the air conditioner can simulate the odor and temperature of the target environment. When a person is in the enclosed space, it is like being in the distant target environment.

### BACKGROUND OF THE INVENTION

### 1. Field of the Invention

The present invention relates to an environment presentation system, and in particular, to a remote environment presentation system that integrates visual, auditory, olfactory, and somatosensory senses.

### 2. Description of the Related Art

People love traveling, and can increase experience of unknown environments in other countries through traveling. Besides, people also look forward to visiting again liked places that were visited previously. The experience of unknown or familiar liked environments is a concrete manifestation of human beings' pursuit of satisfaction. However, considering the costs of transportation, these desirable feelings sometimes come at a high price. Therefore, in order to meet people's needs that are hard to satisfy, many technologies have provided solutions.

With the thriving of the Internet, a lot of distant or foreign information can be obtained on relevant webpages, and people can also find memories from previous digital records. For example, young people who have never been to Kansai Japan can watch the changing sceneries of four seasons in YouTube™ videos introducing the Kinkakuji Temple; and friends who miss the trip to Hawaii can browse photos that they took and recall the excitement of surfing. However, no matter how close to reality these messages are, people's experience is always deeply unsatisfactory. The reason is as follows: Because people's experience of an environment includes not only the visual sense, but also auditory, olfactory, and even skin somatosensory senses. The sum of all senses is people's true feelings about the environment.

How to allow people's eyes, ears, noses, and skin to be as close as possible to current situations of environments that they want to visit in person without traveling far away, so as to obtain a real sense of being involved in the environments is a challenge.

### SUMMARY OF THE INVENTION

This paragraph extracts and compiles some features of the present invention. Other features will be described in subsequent paragraphs. This is intended to cover various modifications and similar arrangements within the spirit and scope of the appended claims.

In order to meet the above needs, the present invention proposes a remote environment presentation system, which includes: a plurality of audio-visual capturing modules, where each audio-visual capturing module is mounted in a different target environment to obtain audio-visual information corresponding to the target environment, and transmits the audio-visual information to the outside through a network in a streaming manner; a relay server, receiving the audio-visual information from each audio-visual capturing module, and after receiving a specified signal, transferring, through the network in the streaming manner to a source that sends the specified signal, the audio-visual information and related information of a target environment specified by the specified signal; a selector, allowing a user to select one target environment from a plurality of target environments to send the corresponding specified signal; a fragrance sprayer, atomizing and spraying a plurality of fragrances in an enclosed space, where each specified signal corresponds to at least one fragrance type; a video playback device; a sound playback device; an air conditioner adjusting a temperature in the enclosed space; and a central control device informatively connected to the relay server and a weather information server through network, and in signal connection with the selector, the fragrance sprayer, the video playback device, the sound playback device, and the air conditioner to perform the following operations: after receiving the specified signal, sending the specified signal to the relay server; receiving and forwarding the audio-visual information and the related information from the relay server that correspond to the specified signal; playing a video part and a sound part in the received audio-visual information through the video playback device and the sound playback device respectively; notifying the fragrance sprayer of at least one fragrance type corresponding to the received specified signal, to spray at least one fragrance accordingly; and obtaining a current temperature value of a location of the target environment from the weather information server, and notifying the air conditioner to adjust the temperature in the enclosed space to the temperature value.

According to the present invention, the selector may include: an openable protecting cover with two protecting plates, the two protecting plates being bendably connected to form a connecting portion; a flexible circuit board that has a plurality of output/input interfaces and is mounted inside the connecting portion; a first wireless transmission module mounted on the flexible circuit board for signal connection with the central control device; a plurality of flat display modules movably connected to the connecting portion on a connecting side, wherein display surfaces of every two flat display modules face each other to form a display combination, the two flat display modules are respectively equipped with a magnet to maintain opening and closing between the two flat display modules, one of the flat display modules is equipped with an optical distance detector, if the two flat display modules are separated by external force, the optical distance detector detects increase in a distance between the two flat display modules and sends an opening signal, and the opening signal sent by each optical distance detector corresponds to a specified signal; and a first processor mounted on the flexible circuit board and in signal connection with the first wireless transmission module, the flat display modules, and the optical distance detector, to perform the following operations: sending a specified signal corresponding to the received opening signal to the central control device through the first wireless transmission module; receiving the relevant information about the sent specified signal from the central control device, and displaying the received relevant information through the display combination of the optical distance detector that sends the opening signal.

According to the present invention, the selector may further include a first power module, wherein the first power module is electrically connected to the first wireless transmission module, the flat display modules, the optical distance detector, and the first processor, to provide power required for operation of the components. The first power module includes a plurality of secondary batteries that provide direct current power or a transformer that converts mains power into direct current power.

Preferably, the flat display module is an LED display module, an OLED display module, or a liquid crystal display module, the video playback device is a projector or a television, and the sound playback device is a speaker or a headphone.

According to the present invention, the central control device may further include: a second wireless transmission module in wireless signal connection with the first wireless transmission module to send and receive signals; a network communication module informatively connected to the relay server and the weather information server through network; a video transmission module in information connection with the video playback device to send the video part in the audio-visual information to the video playback device for playing; a sound transmission module in information connection with the sound playback device to send the sound part in the audio-visual information to the sound playback device for playing; a third wireless transmission module, transmitting a first control signal to the fragrance sprayer to spray at least one fragrance accordingly, and transmitting a second control signal to the air conditioner to adjust the temperature in the enclosed space to the temperature value; a second controller informatively connected with the second wireless transmission module, the network communication module, the video transmission module, the sound transmission module, and the third wireless transmission module to control operation of the components; and a second power module electrically connected to the second wireless transmission module, the network communication module, the video transmission module, the sound transmission module, the third wireless transmission module, and the second controller to provide power required for operation of the components.

Preferably, the first wireless transmission module and the second wireless transmission module are both Bluetooth modules or Wi-Fi modules, the network communication module is an Ethernet transmission module, a 4G communication module, a 5G communication module, or a Wi-Fi module, the video transmission module is an HDMI module or a VGA module, the sound transmission module is a Bluetooth module, a USB module, or an HDMI module, and the second power module includes a plurality of secondary batteries that provide direct current power or a transformer that converts mains power into direct current power.

According to the present invention, the fragrance sprayer can further include: a plurality of storage boxes, where each storage box stores a type of fragrance; an electronically controlled spray module, controlled to select the fragrance in any storage box for continuous atomization and spraying or alternately atomize and spray fragrances in several storage boxes; a control signal receiving module, receiving the first control signal from the third wireless transmission module; a third controller in signal connection with the electronically controlled spray module and the control signal receiving module, and determining, by analyzing the first control signal, a type of fragrance to be sprayed, and controlling the electronically controlled spray module to atomize and spray the corresponding fragrance.

Preferably, the third wireless transmission module and the control signal receiving module are both infrared signal transmitting modules, Wi-Fi modules, or Bluetooth modules.

According to the present invention, if two optical distance detectors send the opening signal one after another, the first processor only processes the opening signal of the optical distance detector that sends the signal first.

Preferably, the relay server can adjust the correspondence between the specified signal and the target environment and update content of the relevant information through mobile communication software on a mobile communication device that is informatively connected to the relay server.

The present invention utilizes the audio-visual capturing module to obtain images and surrounding sounds of a distant target environment and presents them in an enclosed space through the video playback device and the sound playback device. The fragrance sprayer and the air conditioner can simulate the odor and temperature of the target environment. When a person is in the enclosed space, it is like being in the distant target environment, thereby satisfying the foregoing needs.

### BRIEF DESCRIPTION OF THE DRAWINGS

FIG. 1 is a schematic diagram of components of a remote environment presentation system according to an embodiment of the present invention;

FIG. 2 is a side view of a selector in a usage state;

FIG. 3 is a side view of a selector in a non-usage state;

FIG. 4 illustrates a state in which two flat display modules of a third display combination are separated;

FIG. 5 is a schematic cross-sectional diagram of components of a fragrance sprayer; and

FIG. 6 illustrates technical components in a central control device.

### PREFERRED EMBODIMENT OF THE PRESENT INVENTION

The present invention will be described in more detail with reference to the following embodiments.

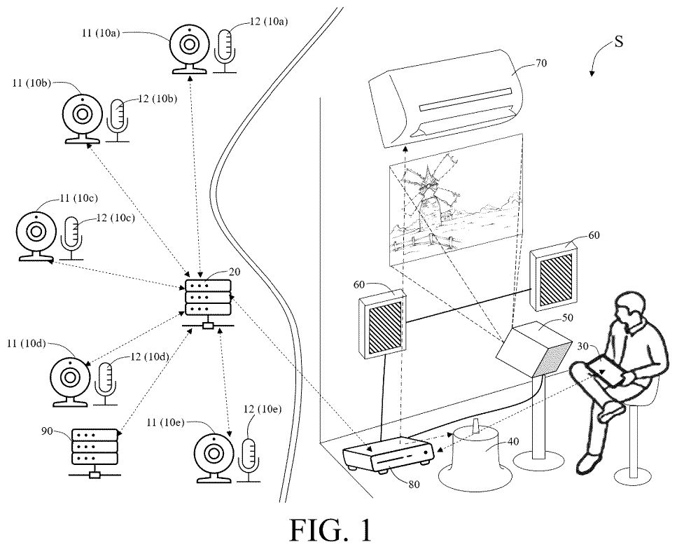

FIG. 1 is a schematic diagram of components of a remote environment presentation system according to an embodiment of the present invention. The remote environment presentation system includes several audio-visual capturing modules (in this embodiment, five audio-visual capturing modules are used as an example for illustration: a first audio-visual capturing module 10a, a second audio-visual capturing module 10b, a third audio-visual capturing module 10c, a fourth audio-visual capturing module 10d, and a fifth audio-visual capturing module 10e, and the actual number is limited to 5 and is at least 2 and can be more), a relay server 20, a selector 30, a fragrance sprayer 40, a video playback device 50, a sound playback device 60, an air conditioner 70, and a central control device 80. The types, functions, installation locations, and interaction methods between these technical components will be described in detail below with reference to relevant diagrams.

According to the present invention, all audio-visual capturing modules in the embodiments include a video capturing unit and a sound capturing unit. The video capturing unit is, for example, a network camera 11, and the sound capturing unit is, for example, a wireless microphone 12. Each audio-visual capturing module is mounted in a different target environment to obtain audio-visual information corresponding to the target environment. The target environment is an environment in which the audio-visual capturing module needs to obtain a specific video and background sound surrounding the specific video, that is, a specific geographical location range of the audio-visual information. For example, the first audio-visual capturing module 10a is mounted outside a small shop in an alley in Ginza Tokyo, and the target environment is the alley in Ginza Tokyo; the second audio-visual capturing module 10b is mounted on a door of an apartment near Central Park New York, and the target environment is surrounding area near Central Park New York; the third audio-visual capturing module 10c is mounted near a waterwheel house in the suburbs of Amsterdam, and the target environment is a scene in the suburbs of Amsterdam; the fourth audio-visual capturing module 10d is mounted on a small pavilion by West Lake Hangzhou, and the target environment is the Broken Bridge of West Lake Hangzhou; and the fifth audio-visual capturing module 10e is mounted on the railing of a resort in the Gold Coast in Australia, and the target environment is a section of the Gold Coast. These audio-visual capturing modules obtain the audio-visual information of the target environment in the scenic spots at all times without interruption, and transmit the audio-visual information to the outside through a network in a streaming manner. Devices that obtain the audio-visual information can present the audios and videos of these scenic spots in real time at a distance, allowing people who have never visited to satisfy their curiosity, and allowing people who have visited before to recall the good times.

The relay server 20 receives the audio-visual information from each audio-visual capturing module, and may process the audio-visual information by forwarding the information to a required terminal, or by temporarily storing the information therein. Regarding forwarding audio-visual information, after receiving a specified signal, the relay server 20 can transmit, through a network in a streaming manner to a source that sends the specified signal, the audio-visual information and related information of the target environment specified by the specified signal. The specified signal is a signal that requests the forwarding of audio-visual information of a specific source, and specifically indicates a target environment (the audio-visual capturing module) of the audio-visual information that the relay server 20 needs to forward. For example, the target environment specified by the specified signal is near Central Park New York, and the audio-visual information comes from the second audio-visual capturing module 10b. Relevant information refers to information related to the location of the audio-visual capturing module, for example, longitude and latitude coordinates of the location, representative photos, description of the surrounding area of the location, and a local time, but is not limited thereto. The source that sends the specified signal is the selector 30.

The selector 30 is a device that allows the user to select a target environment from a plurality of target environments to send a corresponding specified signal to the relay server 20 through the central control device 80, and functions like a remote control of a television to select synchronized audios and videos of a remote place to be experienced. In order to achieve the above purpose, the selector 30 includes an openable protecting cover 31, a flexible circuit board 32, a first wireless transmission module 33, several flat display modules 34, a first processor 35, and a first power module 36.

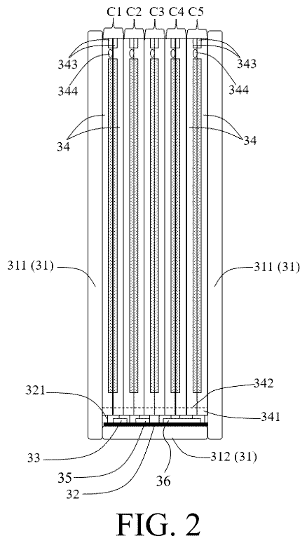

FIG. 2 is a side view of the selector 30 in a usage state. The openable protecting cover 31 has two protecting plates 311, and the two protecting plates 311 are bendably connected to form a connecting portion 312. In appearance, the openable protecting cover 31 looks like a book cover, and the selector 30 looks like a book. The flexible circuit board 32 has a plurality of input/output interfaces, such as a plurality of flat cables 321 in FIG. 2, and the flexible circuit board 32 is mounted on an inner side of the connecting portion 312. The first wireless transmission module 33 is mounted on the flexible circuit board 32 for signal connection with the central control device. In practice, the first wireless transmission module 33 may be a Bluetooth module or a Wi-Fi module.

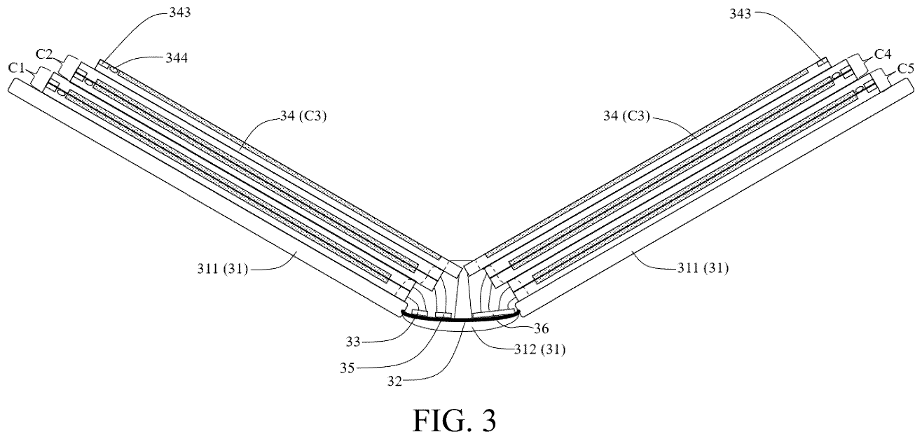

The flat display module 34 is, for example, an LED display module, an OLED display module, or a liquid crystal display module, and is a tool used in the selector 30 to select a target environment and display relevant information of the selected target environment. One of the features of the flat display module 34 of the present invention is the flexible and movable assembly. The flat display module 34 is movably connected to the connecting portion 312 on a connecting side 341, for example, connected by several elastic lines 342 shown in dotted lines. Display surfaces (indicated by black dots) of every two flat display modules 34 face each other to form a display combination (in this embodiment, 10 flat display modules 34 are used as an example for illustration, but the actual number is not limited to this; these flat display modules 34C form five display combinations: a first display combination C1, a second display combination C2, a third display combination C3, a fourth display combination C4, and a fifth display combination C5). The two flat display modules are each equipped with a magnet 343 to maintain opening and closing between the two flat display modules. An optical distance detector 344 is mounted on one of the two flat display modules. FIG. 3 is a side view of the selector 30 in a non-usage state. Taking the third display combination C3 as an example, if the two flat display modules 34 are separated by external force, the optical distance detector 344 detects the increase in the distance between the two flat display modules and sends an opening signal. The content of the opening signal sent by each optical distance detector is different, and each opening signal corresponds to a specified signal. For example, the specified signal specifying the alley of Ginza Tokyo corresponds to the opening signal sent by the optical distance detector 344 of the first display combination C1, the specified signal specifying the surrounding area near Central Park New York corresponds to the opening signal sent by the optical distance detector 344 of the second display combination C2, the specified signal specifying a scene in the suburbs of Amsterdam corresponds to the opening signal sent by the optical distance detector 344 of the third display combination C3, and the specified signal specifying the Broken Bridge of West Lake Hangzhou corresponds to the opening signal sent by the optical distance detector 344 of the fourth display combination C4, and the specified signal specifying a section of the Gold Coast corresponds to the opening signal sent by the optical distance detector 344 of the fifth display combination C5. As shown in FIG. 3, the optical distance detector 344 of the third display combination C3 sends the opening signal.

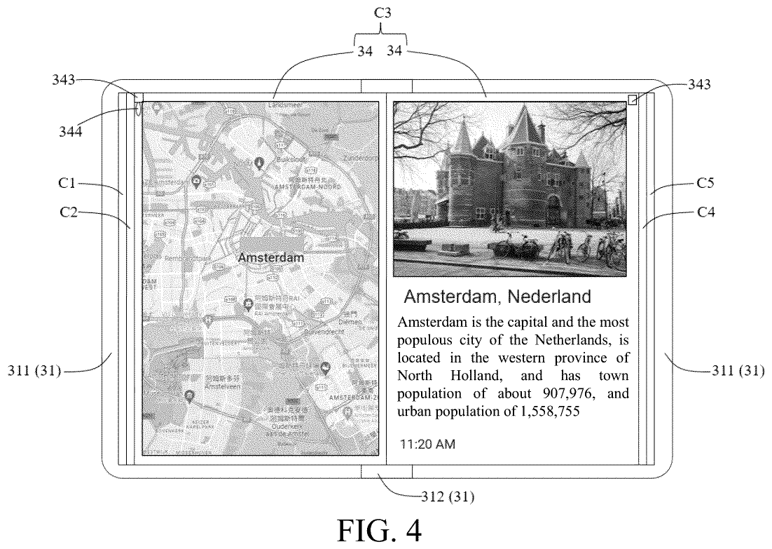

The first processor 35 is mounted on the flexible circuit board 32 and is in signal connection with the first wireless transmission module 33, the flat display modules 34, and the optical distance detectors 344. The first processor 35 is a special chip that can perform the following operations. A first operation is to send the specified signal corresponding to the opening signal received from any optical distance detector 344 to the central control device 80 through the first wireless transmission module 33. A second operation is to receive the relevant information that is from the central control device 80 and that is specified by the sent specified signal, and display the received relevant information through the display combination of the optical distance detector 344 that sends the opening signal. Continuing from the above example, the display combination of the optical distance detector 344 is the third display combination C3. FIG. 4 illustrates a state in which two flat display modules 34 of a third display combination C3 are separated. Since the user “opens” the third display combination C3, it indicates that the user wants to display a scene of the suburbs of Amsterdam, the optical distance detector 344 on the flat display module 34 of the third display combination C3 sends a specified signal specifying a scene of the suburbs of Amsterdam to obtain corresponding relevant information. The flat display module 34C on the left presents a map near the location of the third audio-visual capturing module 10c (obtained according to longitude and latitude coordinates). The flat display module 34C on the left presents a representative photo of a scene in the suburbs of Amsterdam, description of the surrounding area of the location, and a local time. If two optical distance detectors send the opening signal one after another, that is, two display combinations are “opened” one after another, according to the present invention, the first processor 35 only processes the opening signal of the optical distance detector that sends the signal first. In other words, only one display combination is operating at a time. When the two display combinations are “opened” one after another, the display combination opened later functions only if the display combination opened first is closed.

The first power module 36 is electrically connected to the first wireless transmission module 33, the flat display modules 34, the optical distance detectors 344, and the first processor 35 to provide power required for operation of the components. The first power module may include a plurality of secondary batteries that provide direct current power or a transformer that converts mains power into direct current power. It should be emphasized that the selector 30 is only for the user to select the target environment and provides relevant information of the target environment to let the user know, but is not a component that presents the remote environment.

The fragrance sprayer 40 is a device used in the present invention to present a special “smell” in the target environment, and the “smell” is simulated by the fragrance. Perhaps the tulip fragrance can simulate the smell of a scene in the suburbs of Amsterdam because Tulips are planted everywhere in this place, but in most cases, several fragrances are used to simulate these “smells” to be closer to reality. The fragrance sprayer 40 can atomize and spray several fragrances in an enclosed space S. Herein, the enclosed space S refers to a specific space that presents a remote environment, such as an indoor room. For the specified signal mentioned above, each specified signal corresponds to at least one fragrance type. For example, the specified signal sent by the first processor 35 corresponding to the opening signal from the optical distance detector 344 of the fourth display combination C4 specifies the Broken Bridge of West Lake Hangzhou as the target environment. Therefore, the fragrance type corresponding to the specified signal may include osmanthus fragrance.

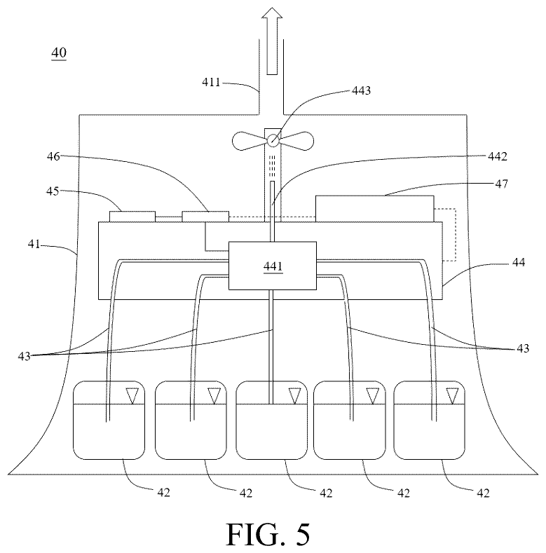

FIG. 5 is a schematic cross-sectional diagram of components of a fragrance sprayer 40. In order to achieve the aforementioned functions, the fragrance sprayer 40 has the following structure. The fragrance sprayer 40 has a housing 41 specifically shaped to protect the components inside. A spray outlet 411 is formed above the housing 41 for spraying atomized fragrance. The housing 41 includes several storage boxes 42, each storage box 42 stores a type of fragrance, and the storage box 42 flows the fragrance inside to the outside through a suction pipe 43. The fragrance sprayer 40 has an electronically controlled spray module 44, which can be controlled to select the fragrance in any storage box 42 for continuous atomization and spraying or alternately atomize and spray fragrances in several storage boxes 42. Furthermore, the electronically controlled spray module 44 includes a water suction motor assembly 441, an essential oil outlet pipe 442, and an atomizing fan 443. The water suction motor assembly 441 includes a plurality of water suction motors (not shown), and each water suction motor is connected to a suction pipe 43. The water suction motor assembly 441 can be controlled to determine one or several water suction motors to be activated. The essential oil sucked out by the water suction motor assembly 441 moves upward through the essential oil outlet pipe 442. Finally, the atomizing fan 443 is started to atomize the essential oil, and then sprays toward the spray outlet 411 at an accelerated speed. The fragrance sprayer 40 has a control signal receiving module 45 that receives the first control signal from the third wireless transmission module of the central control device 80. The first control signal notifies the fragrance sprayer 40 to spray at least one fragrance accordingly. The fragrance sprayer 40 also has a third controller 46. The third controller 46 is in signal connection with the electronically controlled spray module 44 and the control signal receiving module 45 (indicated by thin solid lines), and determines, by analyzing the first control signal, a type of fragrance to be sprayed, and controls the electronically controlled spray module 44 to atomize and spray the corresponding fragrance. In order to provide power, the fragrance sprayer 40 also has a third power module 47, such as a set of secondary batteries. The third power module 47 is electrically connected to the electronically controlled spray module 44 and the third controller 46 (indicated by dotted lines), and can provide power for operation of the components.

The video playback device 50 is a device used in the present invention to present the video of the target environment in the enclosed space S. According to the present invention, the video playback device 50 may be a projector or a television, and is a projector in this embodiment. The sound playback device 60 is a device used in the present invention to present the sound of the target environment in the enclosed space S. According to the present invention, the sound playback device 60 may be a speaker or a headphone, and is a set of speakers in this embodiment.

According to the present invention, the air conditioner 70 can be various air-conditioners, heaters, air exchangers, and the like, and can circulate the air in the enclosed space S to adjust the temperature (increase or decrease the temperature) in the enclosed space S. The air conditioner 70 can be an existing product on the market, and is operated in a wireless manner through infrared, Wi-Fi or Bluetooth signals. The purpose of the air conditioner 70 is to maintain the temperature of the enclosed space S at the same temperature as the target environment, so that the user's body surface can sense whether the target environment is cold or warm.

The central control device 80 is a device in the remote environment presentation system to control the operation of components in the enclosed space S. The central control device 80 is externally and informatively connected to the relay server 20 and a weather information server 90 through network, and is internally in signal connection with the selector 30, the fragrance sprayer 40, the video playback device 50, the sound playback device 60, and the air conditioner 70. The central control device 80 performs the following operations. A first operation is to send the specified signal to the relay server 20 after receiving the signal. After receiving the specified signal, the relay server 20 sends audio-visual information and related information corresponding to the specified signal. A second operation is to receive and forward the audio-visual information and related information corresponding to the specified signal from the relay server 20. A third operation is to play the video part and the sound part in the received audio-visual information through the video playback device 50 and the sound playback device 60 respectively to generate the experience of the video and the sound. A fourth operation is to notify the fragrance sprayer 40 of at least one fragrance type corresponding to the received specified signal to spray at least one fragrance accordingly, thereby simulating a special “smell” in the target environment. A fifth operation is to obtain a current temperature value of the location of the target environment from the weather information server 90, and notify the air conditioner 70 to adjust the temperature in the enclosed space S to the temperature value. That is, in the present invention, a thermometer does not need to be provided in the target environment. The temperature of the target environment can also be obtained from public information and presented in the enclosed space S through the air conditioner 70.

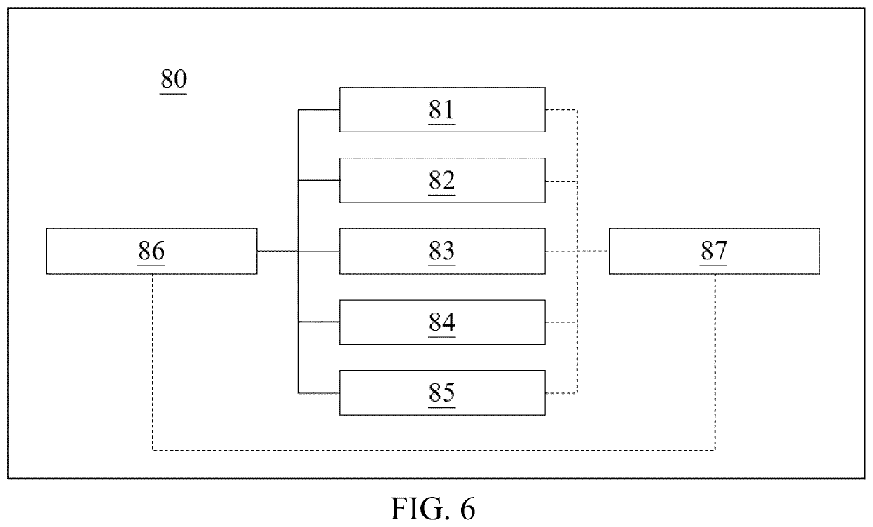

FIG. 6 illustrates technical components of the central control device 80. In order to be able to perform the above operations, the central control device 80 further includes: a second wireless transmission module 81, a network communication module 82, a video transmission module 83, a sound transmission module 84, a third wireless transmission module 85, a second controller 86, and a second power module 87.

The second wireless transmission module 81 is in wireless signal connection with the first wireless transmission module 33 to send and receive signals. Each of the second wireless transmission module 81 and the first wireless transmission module 33 is also a Bluetooth module or a Wi-Fi module. The network communication module 82 is informatively connected to the relay server 20 and the weather information server 90 through network. In practice, the network communication module 82 can be an Ethernet transmission module, a 4G communication module, a 5G communication module or a Wi-Fi module, and can send and receive audio-visual information and related information in a wired or wireless manner. The video transmission module 83 is connected to the video playback device 50 to send the video part in the audio-visual information to the video playback device 50 for playback. According to the present invention, the video transmission module 83 is an HDMI module or a VGA module. The sound transmission module 84 is connected to the sound playback device 60 to send the sound part in the audio-visual information to the sound playback device 60 for playing. Since a transmission volume of sound files is smaller than a transmission volume of image files, the sound transmission module 84 can be of more diverse types, for example, Bluetooth modules, USB modules, and HDMI modules, but is not limited thereto. The third wireless transmission module 85 is a technical component configured to control the fragrance sprayer 40 and the air conditioner 70, and can transmit the first control signal to the fragrance sprayer 40 to spray at least one fragrance accordingly, and transmit a second control signal to the air conditioner 70 to adjust the temperature in the enclosed space S to the temperature value. In practice, the third wireless transmission module 85 and the control signal receiving module 45 can both be infrared signal transmitting modules, Wi-Fi modules or Bluetooth modules. The second controller 86 is in information connection with the second wireless transmission module 81, the network communication module 82, the video transmission module 83, the sound transmission module 84, and the third wireless transmission module 85 (indicated by solid line connections), and can control the operation of the components. The second power module 87 is electrically connected to the second wireless transmission module 81, the network communication module 82, the video transmission module 83, the sound transmission module 84, the third wireless transmission module 85 and the second controller 86 (indicated by dotted line connections), to provide the power required for the operation of the components. In practice, the second power module 87 may include several secondary batteries that provide direct current power, or a transformer that converts mains power into direct current power, so as to directly supply direct current power or convert alternating current power into direct current power.

It should be noted that the remote environment presentation system can present remote real-time environments to different users in plurality of closed spaces S at the same time. Therefore, a plurality of selectors 30, a plurality of fragrance sprayers 40, a plurality of video playback devices 50, a plurality of sound playback devices 60, a plurality of air conditioners 70 and a plurality of central control devices 80 may be combined, and are respectively mounted in plurality of closed spaces S according to requirements.

The number of flat display modules 34 in the selector 30 is limited, but the number of audio-visual capturing modules scattered around the world has no upper limit. Therefore, to use a limited number of flat display modules 34 to display audio-visual information from a large number of audio-visual capturing modules, tradeoff needs to be made at the same time, that is, the target environment specified by each specified signal may change according to user's needs. Therefore, the relay server 20 can adjust the correspondence between the specified signal and the target environment and update content of the relevant information through mobile communication software on a mobile communication device that is informatively connected to the relay server 20 and operated by a user.

Although the present invention has been disclosed in the above embodiments, it is not intended to limit the present invention. Anyone with ordinary knowledge in the technical field can make some modifications and embellishments without departing from the spirit and scope of the present invention. Therefore, the protection scope of the present invention shall be subject to the scope of the attached claims.

What is claimed is:

1. An environment presentation system in an enclosed space, comprising:
a relay server configured to receive audio-visual information in real time corresponding to a plurality of environments;
a central control device connected to the relay server, wherein the central control device is configured to send a specified signal to the relay server and receive a first information part of the audio-visual information corresponding to the specified signal, wherein the specified signal indicates a target environment of the environments;
a video playback device connected to the central control device and configured to present a video of the target environment in real time based on the first information part; and
an air conditioner connected to the central control device and configured to adjust a temperature in the enclosed space based on the first information part.

2. The environment presentation system of claim 1, wherein the audio-visual information are captured by a plurality of audio-visual capturing modules mounted in the plurality of environments.

3. The environment presentation system of claim 1, wherein the relay server is configured to sends related information of the target environment specified by the specified signal, wherein the related information comprises at least one of the following: a location of an audio-visual capturing module mounted in the target environment, representative photos of the target environment, descriptions of a surrounding area of the target environment, and a local time of the target environment.

4. The environment presentation system of claim 1, further comprising a sound playback device configured to present a sound of the target environment in real time based on the first information part.

5. The environment presentation system of claim 4, wherein the video and the sound of the target environment are synchronized.

6. The environment presentation system of claim 1, wherein the air conditioner is configured to adjust the temperature in the enclosed space to a current temperature value of a location of the target environment from an external weather information server.

7. The environment presentation system of claim 1, further comprising a fragrance sprayer connected to the central control device and configured to spray at least one fragrance based on the specified signal, wherein the at least one fragrance corresponds to the target environment.

8. The environment presentation system of claim 7, wherein the fragrance sprayer atomizes and sprays a plurality of fragrances in the enclosed space.

9. The environment presentation system of claim 8, wherein the fragrance sprayer comprises an electronically controlled spray module, a plurality of storage boxes storing different fragrances, and wherein the electronically controlled spray module is configured to select at least one of the fragrances of the storage boxes for continuous or alternative atomization and spraying in the enclosed space.

10. The environment presentation system of claim 1, further comprising a selector connected to the central control device, wherein the selector comprises:
an openable protecting cover having a connection portion;
a plurality of flat display modules movably connected to the connecting portion;
a flexible circuit board mounted on the connecting portion;
a wireless transmission module mounted on the flexible circuit board; and
a processor mounted on the flexible circuit board and configured to implement the following operations:
sending the specified signal to the central control device through the wireless transmission module;
receiving relevant information specified by the specified signal from the central control device through the wireless transmission module; and
displaying the relevant information by at least one of the flat display modules.

11. The environment presentation system of claim 10, wherein the selector further comprises an optical distance detector mounted on one of a first pair of flat display modules of the flat display modules, wherein the optical distance detector is configured to detect an increment of a distance between the first pair of flat display modules and sends an opening signal to the processor.

12. A method of presenting an environment in an enclosed space, the method comprising:
receiving, by a relay server, audio-visual information in real time corresponding to a plurality of environments;
sending, by a central control device, a specified signal to the relay server;
receiving, by the central control device, a first information part of the audio-visual information corresponding to the specified signal, wherein the specified signal indicates a target environment of the environments;
presenting, by a video playback device, a video of the target environment in real time based on the first information part; and
adjusting, by an air conditioner, a temperature in the enclosed space based on the first information part.

13. The method of claim 12, further comprising presenting, by a sound playback device, a sound of the target environment in real time based on the first information part.

14. The method of claim 13, wherein the video and the sound of the target environment are synchronized.

15. The method of claim 12, further comprising adjusting, by the air conditioner, the temperature in the enclosed space to a current temperature value of a location of the target environment from an external weather information server.

16. The method of claim 12, further comprising spraying, by a fragrance sprayer, at least one fragrance based on the specified signal, wherein the at least one fragrance corresponds to the target environment.

17. The method of claim 12, further comprising:
sending, by a processor of a selector, the specified signal to the central control device through a wireless transmission module;
receiving, by the processor of the selector, relevant information specified by the specified signal from the central control device through the wireless transmission module; and
displaying the relevant information by at least one of a plurality of flat display modules of the selector.

18. A selector for selecting a target environment to be presented from a plurality of environment, comprising:
an openable protecting cover having a connecting portion;
a plurality of flat display modules movably connected to the connection portion;
a flexible circuit board mounted on the connecting portion;
a wireless transmission module mounted on the flexible circuit board; and
a processor mounted on the flexible circuit board and configured to implement the following operations:
sending a specified signal through the wireless transmission module;
receiving relevant information specified by the specified signal; and
displaying the relevant information by at least one of the flat display modules.

19. The selector of claim 18, further comprising an optical distance detector mounted on one of a first pair of flat display modules of the flat display modules, wherein the optical distance detector is configured to detect an increment of a distance between the first pair of flat display modules and sends an opening signal to the processor.

20. The selector of claim 19, wherein the specified signal corresponds to the opening signal.
